(19) United States
(12) Patent Application Publication
(10) Pub. No.: US 2015/0338543 A1
(43) Pub. Date: Nov. 26, 2015

(54) RELATING TO GEOLOGICAL LOGGING

(71) Applicant: Reeves Wireline Technologies Limited, Leicestershire (GB)

(72) Inventor: Terence Paul Mayor, Nottingham (GB)

(21) Appl. No.: 14/715,785

(22) Filed: May 19, 2015

(30) Foreign Application Priority Data
May 23, 2014 (GB) 1409280.3

(51) Int. Cl. G01V 3/38; G01V 3/32

(52) U.S. Cl. CPC G01V 3/38; G01V 3/32

(57) ABSTRACT

A method of improving geological log data comprises the steps of:
(i) moving a drillpipe-conveyed logging tool in a borehole in a formation while operating the logging tool to obtain log data of a first category;
(ii) periodically halting the logging tool supported by the drillpipe;
(iii) while the logging tool is halted, obtaining log data of at least a second category; and
(iv) processing or storing the log data of the second category and/or using the log data of the second category to improve the quality of the data of the first category and/or combining the data of the first and second categories.

### FIELD OF THE INVENTION

The invention concerns improvements in or relating to geological logging. In particular the invention concerns methods of acquiring geological log data. The logging of geological formations is, as is well known, economically an extremely important activity.

### BACKGROUND OF THE INVENTION

A geological formation may be penetrated by a borehole, hole or wellbore (these terms being generally similar in meaning) for the purpose of assessing the nature of, or extracting, a commodity of commercial value that is contained in some way in the formation. Examples of such commodities include but are not limited to oils, flammable gases, tar/tar sands, various minerals, coal or other solid fuels, and water.

The terms “uphole”, “downhole”, “bottom hole”, “cased hole”, “open hole”, “sonde”, “total depth”, “drillpipe”, “borehole”, “well”, “wellbore”, and “formation” as may appear herein are familiar in the oil and gas exploration and completion industries. The person of skill in the art would understand these terms to have their conventional meanings.

Other terms of relevance to the invention are defined or explained herein as necessary.

Virtually all commodities used by mankind are either farmed on the one hand or are mined or otherwise extracted from the ground on the other, with the extraction of materials from the ground providing by far the greater proportion of the goods used by humans.

It is strongly desirable for an entity wishing to extract materials from beneath the ground to have as good an understanding as possible of the conditions prevailing in a region from which extraction is to take place.

This is needed partly so that an assessment can be made of the quantity and quality, and hence the value, of the materials in question; and also because it is important to know whether the extraction of such materials is likely to be problematic.

The acquisition of such data typically makes use of techniques of logging. Logging techniques are employed throughout the mining industry, and also in particular in the oil and gas industries. The invention is of benefit in logging activities potentially in all kinds of mining and especially in the logging of reserves of oil and gas, solid fuels, water and other minerals of commercial value.

In the logging of oil and gas fields (or indeed geological formations containing other fluids) specific problems can arise. Broadly stated this is because it is necessary to consider a geological formation that typically is porous and that contains a hydrocarbon-containing fluid such as oil or gas or (commonly) a mixture of fluids only one component of which is of commercial value.

This leads to various complications associated with determining physical and chemical attributes of the oil or gas field in question. In consequence a wide variety of logging methods has been developed over the years. The logging techniques exploit physical and chemical properties of a formation usually through the use of a logging tool or sonde that is lowered or inserted into a borehole (that typically is, but need not be, a wellbore) formed in the formation by drilling.

Typically the tool sends energy generated by a source into the formation and detects the energy returned to it that has been altered in some way by the formation. The nature of any such alteration can be processed into electrical signals that are then used to generate logs (i.e. graphical or tabular representations containing much data about the formation in question).

Various types of logging tool are known, including but not limited to resistivity, nuclear, acoustic, gamma and nuclear magnetic resonance (NMR) types. The names of these various tool types indicate the nature of the source in each case. In its broad form the invention is of utility potentially in the use of all types of logging tool, and is of particular benefit in the case of nuclear, acoustic and NMR logging tools. Details of all the aforesaid logging tools will be familiar to the person of skill in the art.

A further branch of logging involves the detection of natural radiation levels, in a geological formation, that are indicative of radioactive decay of certain isotopes. Knowledge of the relative amounts of radiation that are attributable to the respective isotopes can allow a log analyst to infer certain characteristics of the formation. The invention is of utility in relation to this type of logging activity as well.

Alternatively the tool might act as a passive detector of formation properties. Examples include Spontaneous Potential, and the local magnetic field properties, but as stated of direct interest is the detection of the natural radioactive decay of elements within the formation. The detection can be made in a gross (total count rate) mode or in a specific energy range to infer the presence of a particular element (spectral detection).

Regardless of the precise logging technique under consideration, typically a logging tool is constituted as an elongate, rigid structure sometimes called a logging toolstring. This is made up of connected subcomponents (or “subs”) that are joined together using screw joints or other fixings to create a composite device the precise make-up of which is determined according to the logging requirement and the expected downhole conditions.

In broad terms a toolstring includes a series of elongate elements that are secured to one another end to end for use in such a downhole environment. When employed for the purpose of logging a toolstring includes one or more sondes that are capable of carrying out logging method steps.

Usually the toolstrings resemble elongate, rigid cylinders that might be 2 m or more in length and between about 50 mm (2⅛ inches) or less and 200 mm (8 inches) in diameter. A toolstring containing a sonde might be considerably longer, with toolstring lengths in the range 5-50 m being known.

Many logging tools are conveyed into boreholes suspended from wireline, the nature of which is known to the person of skill in the art. Wireline may be considered as armoured cable that serves the twin purposes of supporting a logging tool inserted into a downwardly descending borehole and telemetering data and commands between the logging tool and a surface location.

In particular the wireline may send operational commands from the surface location in order to cause deployment or activation of the logging tool; and may transmit log data from the logging tool to the surface location, where it is processed and analysed.

Increasingly commonly however wireline logging is regarded as inefficient or even impossible to achieve. This is in part because of the growth in the use of boreholes at least parts of which are drilled substantially horizontally or only shallowly inclinedly e.g. into a hillside or subsea ridge. In other examples the boreholes may include both steeply downwardly inclined and horizontal or near-horizontal sections in order to maximize the length of borehole extending through a gas or oil field. Wireline, which relies on gravity to convey a suspended logging tool, often is unsuitable for use in such situations.

As an alternative to the use of wireline therefore a toolstring may be conveyed from a surface location to a chosen location in a hole, well or borehole, that typically but not necessarily is near its total depth (TD), by being supported on drillpipe that is fed into the well or borehole.

As is well known, drillpipe is elongate, hollow, hardened steel tubing that is provided in the form discrete so-called stands or joints of standard lengths (typically about 10 m/30 feet each) that may be screwed one to another to create long tubes that might be hundreds or thousands of metres long. The rigidity of the drillpipe means that logging engineers are no longer dependent on gravitational suspension of the logging tools on essentially flexible wireline to convey them, thereby permitting the easier logging of non-vertical wells and boreholes.

In more detail, each stand, joint or length of drillpipe includes at one, in use uphole, end a socket that is threaded and at its in-use downhole end a threaded exterior section that can be threadedly received in the socket of an adjacent section of drillpipe. By feeding drillpipe in a downhole direction and adding stands one by one at the uphole end a length of drillpipe may be caused to extend along a hole, borehole or wellbore.

Drillpipe therefore can be used to support various kinds of logging tool in order to permit their conveyance into a well, etc. It is known in this regard to convey logging tools shielded inside the hollow interior of drillpipe while the latter is run in to the location, underground, at which logging is to take place. The logging tool may then be caused to move to protrude from the drillpipe so that logging may commence. The drillpipe is withdrawn at a chosen speed in an uphole direction (with successive stands being removed one by one, two by two or three by three at the surface location as their connections to the adjacent stands below become exposed) while logging of the formation takes place.

In a variant of this approach in some cases it is possible for the logging tool to remain inside the drillpipe as it is withdrawn, and for logging to take place through the material of the drillpipe.

As is well known in the logging arts, logging tools may be constructed as autonomous devices that do not need to be connected to a surface location in order to operate.

Such a tool is suitable for conveyance using drillpipe, and typically includes electrical batteries and one or more memory devices. The tool operates by using the batteries to power the memory devices. As the sonde detects energy either originating within the formation or from the source, the memory devices record log data signals generated by detection devices that form part of the toolstring and are sensitive to the forms of returned energy. Typically the diameters of the autonomous logging tools are less than the wireline-conveyed ones, so that they may readily be housed inside drillpipe and at the appropriate time caused to protrude therefrom.

Once the autonomous logging tool is retrieved to a surface location following logging, log data resulting from the logging process are in one way or another transferred to a computer (that may be at the wellhead, at the rig location or at a location far removed from the oil or gas field under investigation) that through the use of installed software produces logs that typically but not necessarily are in a graphical form. Other software and/or skilled human analysts then can interpret the logs and from them obtain much valuable information about the subterranean conditions in the formation logged.

Autonomous logging tools of the kind described in outline above as indicated are highly suitable for conveying supported on drillpipe as explained in the foregoing.

In the case of a nuclear logging tool of the kinds mentioned above a significant factor in the usefulness of the tool derives from statistical considerations. The statistical nature of the measurement process using nuclear logging tools renders their outputs inherently affected by “noise” the general nature of which is known to the person of skill in the art.

As an example, the determination of natural gamma ray activity of a downhole formation is subject to count rate measurement variations, governed by Poisson statistics. Low count rates are subject to greater uncertainty (i.e. noise) than higher count rates. The degree of uncertainty can be offset by counting for longer times, or increasing the detector volume and efficiency. The measurement process using nuclear logging methods in other words renders their outputs inherently affected by “uncertainty” the magnitude of which is statistical in nature.

A further example is the spectral Gamma sonde, which measures the total and individual natural Gamma ray count rate from the decay of Uranium, Thorium and Potassium components of reservoir rocks. Count rates are measured within fixed energy windows designed to detect the proportion of the three radioactive elements.

A feature of logging tools containing radioactive sources (as contrasted with those mentioned above that measure background radiation) is that they are constrained in their design as to where the radiation detectors can be spaced relative to the source in order to ensure adequate counts are detected.

Yet a further example of nuclear logging is induced gamma ray spectroscopy methods that employ high energy neutron sources to determine elemental concentrations.

Measurements recorded by all the above tool types are all subject to unavoidable statistical fluctuations, which in turn leads to imprecision in the final log results.

It is reasonable to assume the random decay follows a normal or Gaussian distribution¹, and the statistical spread in the data about the mean (x_bar) can be described by the variance or its square root, the standard deviation (σ). For a total number of counts (x) accumulated over a time period (t), the standard deviation a σ=√(x). ¹(1) Whilst radiation decay is strictly described by the mathematics of Binomial statistics, for counts exceeding 17 in a given time the Gaussian distribution is generally sufficient to describe the process.

Describing the fractional standard deviation (f.s.d.) σ/x as the error associated with the measurement, then this is equal to √(x)/x=1/√(x). Then the total number of counts completely determines the fractional error associated with the measurement.

For example, if 100 counts are detected within a given energy range, then the fractional standard deviation is 10%. The uncertainty in the measurement can be reduced to 1% by increasing the total counts recorded to 10,000.

For events described by a count rate measured in counts per second (cps) then an increase in the time for accumulation will automatically decrease the error by 1/√(t).

The same argument holds in the analysis of spectral gamma peak detection as the total number of counts within any predefined energy range is the area under each peak, representing the sum of the counts in the channels constituting the peak.

It is clear from the foregoing that any improvement in the statistics associated with a nuclear log measurement is likely to be of benefit. Hitherto however as noted the only techniques available for improving the statistics of a nuclear logging activity involve increasing the activity of the source; increasing the volume of the detector; or, simply, logging a formation more slowly than would otherwise be the case, in order to increase the number of logged counts.

Both these approaches however are associated with disadvantages. Increasing the source activity gives rise to numerous regulatory and safety problems. Slow logging of a well give rise to potentially very high costs that are unattractive.

In some other cases a very important parameter of a logging operation is the signal to noise ratio (SNR) between the log data signals on the one hand and noise resulting e.g. from movement of the logging tool in the formation. This is a noticeable problem in the case of acoustic tools. It therefore is desirable to improve the SNR in use of such tools if possible.

In particular an adverse SNR effect arises in acoustic tools that are conveyed on drillpipe in horizontal or shallowly inclined boreholes. In such situations the mass of the logging tool acts downwardly against one side of the borehole. This causes vibrations in the tool that, since it includes typically an array of sensitive acoustic transducers, records the vibrations in the log that results from passage of the logging tool along the well.

The vibrations are of no geological value at all, and represent an often dominating degree of noise (sometimes referred to as “road noise”) in the recorded log. There has been a long-felt need to eliminate the effects of road noise from acoustic logs.

NMR logging tools as noted represent another exemplary, non-limiting class of tools in which it is desirable to improve the signal-to-noise ratio, although in NMR logging tools the SNR problem does not derive directly from vibration of the tool caused by road noise.

### SUMMARY OF THE INVENTION

According to the invention in a first aspect there is provided a method of improving geological log data comprising the steps of:
(i) moving a drillpipe-conveyed logging tool in a borehole in a formation while operating the logging tool to obtain log data of a first category;
(ii) periodically halting the logging tool supported by the drillpipe;
(iii) while the logging tool is halted, obtaining log data of at least a second category; and
(iv) processing or storing the log data of the second category and/or using the log data of the second category to improve the quality of the data of the first category and/or combining the data of the first and second categories

Such a method ingeniously takes advantage of the need, when logging using a logging tool being withdrawn upwardly while supported on drillpipe, repeatedly to halt progress in an uphole direction for the purpose of removing each section of drillpipe (or as noted above plural sections at a time) as the drillpipe becomes exposed at the surface location.

It takes perhaps 2-5 minutes to remove each length of drillpipe. This gives rise to an opportunity to continue operating the logging tool at a time when there is no generation of noise resulting from movement of the logging tool and drillpipe in an uphole direction.

Moreover when the tool is stationary a statistically good number of nuclear logging counts can be acquired, in the case of the logging tool being a nuclear logging tool as described. In turn it becomes possible to improve the quality of a log by making use of the noise-free data and/or statistically good data generated while the logging tool is halted.

In other words the method of the invention is of benefit in use of all the logging tool types referred to herein.

In more detail preferably the step (iv) of processing or storing the data of the second category includes using the log data of the second category to improve the quality of the data of the first category.

In particular the step (iv) of processing or storing the data of the second category includes combining the data of the first and second categories; or, in another embodiment of the invention, comparing the data of the first and second categories with one another.

Preferably the method of the invention is repeated multiple times. This takes advantage of the fact that in a typical situation large numbers of drillpipe lengths must be removed sequentially as logging progresses. Therefore the logging tool is halted numerous times as it travels in an uphole direction; and as a result multiple sets of low-noise/statistically good/good SNR data may be obtained.

When the method of the invention involves combining the data of the first and second categories this may be achieved in any of a range of per se known ways, such as but not limited to associating the data of the first category with the data of the second category; or imposing one or more attributes of the data of the second category onto the data of the first category.

Conveniently the logging tool is or includes a nuclear logging tool sonde that preferably is or includes a sonde selected from the list comprising a natural Gamma sonde, a spectral Gamma sonde and an induced Gamma spectroscopy sonde.

The person of skill in the art will understand the meaning of “statistical quality” in the context of the output of a nuclear logging tool. As used herein the term “nuclear logging tool” can refer to e.g. a neutron porosity tool or a gamma logging tool. Various sources and generators of radiation energy are known to be used in such tools; and the invention extends to all such tool types as are suitable for the practising of the method of the invention.

For the avoidance of doubt in preferred embodiments of the invention the log data of the first category are log data acquired while the nuclear logging tool sonde is moving in the borehole and the log data of the second category are log data acquired while the nuclear logging tool sonde is stationary in the borehole, the log data of the second category exhibiting lower fractional standard deviation values than the log data of the first category.

In another preferred embodiment of the invention the logging tool sonde is or includes an acoustic logging tool sonde.

In such an arrangement the log data of the first category conveniently are log data acquired while the acoustic logging tool sonde is moving in the borehole and the log data of the second category are log data acquired while the acoustic logging tool sonde is stationary in the borehole, the log data of the second category exhibiting less noise than the log data of the first category. In particular the data of the second category preferably are less noisy than the data of the first category to an appreciable or significant degree. The person of skill in the art would readily understand and recognise an appreciable or meaningful degree of noise improvement.

Further preferably the log data of the first and second categories in accordance with the method of the invention are subject to processing according to one or more methods selected from the group comprising slowness-time-coherence (STC) processing and slowness-frequency-coherence (SFC) processing.

In another embodiment within the scope of the invention the low-noise or statistically good data can be used to provide confidence in the results of the logging operation acquired while the logging tool is moving. Thus for example statistically good nuclear log data acquired while the logging tool is stationary may be used to confirm (either using a comparison algorithm performed by a computer, or by visually inspecting sections of logs) that a geological feature apparent in a relatively noise-affected part of the log indeed is present, and is not a false indication resulting from the noise.

In yet a further preferred embodiment of the invention the logging tool is or includes a nuclear magnetic resonance logging (NMR) sonde. When the logging tool is so configured or constructed preferably the data of the first category are or include data indicative of one or more transverse relaxation times (T₂ spectra) and/or data indicative of one or more longitudinal relaxation times (T₁ spectra). Such data are known to be characteristic of nuclear magnetic resonance phenomena.

More specifically, preferably when the data of the first category are or include data indicative of one or more transverse relaxation times (T₂ spectra) the data of the second category are or include data indicative of one or more longitudinal relaxation times (T₁ spectra), and vice versa. In other words, for the avoidance of doubt, when the logging tool is or includes an NMR sonde the preferred mode of operation involves recording data indicative of the transverse relaxation times while the logging tool is being withdrawn, and recording data indicative of the longitudinal relaxation times while the logging tool is halted.

Conveniently the data of the second category are or include data indicative of one or more longitudinal relaxation times (T₁ spectra), and the method further preferably includes repeatedly sampling data in the second category while the logging tool is halted. This approach has been found to permit SNR improvements in a similar manner to that in which multiple laboratory experiments are known to improve NMR SNR characteristics.

Preferably the method of the invention includes repeatedly sampling data in the second category while the logging tool is halted and varying a value of inter-echo pulse spacing during such sampling whereby beneficially to produce data of the second category that are indicative of a diffusion spectrum. Additionally or alternatively the method may include repeatedly sampling data in the second category while the logging tool is halted and varying a value of frequency of NMR pulse sequence during such sampling whereby advantageously to produce data of the second category that are indicative of characteristics of different regions of the formation.

Further preferably the method of the invention may include creating a guide log of the density of log data against log depth whereby to assist in the identification of log data respectively of the first category and the second category. The method also may include the step of superimposing the guide log onto the log data of the first and second categories; and/or of adding one or more measures of error confidence to the guide log. Such features permit a log analyst conveniently to have an indication of the accuracy of parts of logs processed in accordance with the method of the invention.

In addition to the foregoing the invention is considered to reside in log data and/or a log generated in accordance with a method as defined herein.

### DESCRIPTION OF THE DRAWINGS

There now follows a description of preferred embodiments of the invention, by way of non-limiting example, with reference being made to the accompanying drawings in which:

FIGS. 1a to 1e are plots of the repeatability of logs of the activity of a series of radioactive beds at simulated logging speeds respectively of 18 metres per minute (FIG. 1a), 12 metres per minute (FIG. 1b), 6 metres per minute (FIG. 1c), 1 metre per minute (FIG. 1d) and 0.1 metres per minute (FIG. 1e) and illustrating how the method of the invention may improve the statistics of nuclear logs of various kinds;

FIG. 2 is a typical prior art “wiggle trace” showing the effect of road noise on the acquisition of acoustic log data acquired using an acoustic logging tool with the left hand track showing a monopole signal and the centre and right hand tracks dipole signals, as are familiar to the person of skill in the art;

FIG. 3 is a similar series of plots to FIG. 2, showing the difference between acoustic log data acquired when the logging tool is moving supported on drillpipe, and data acquired when the tool and drillpipe are stationary;

FIG. 4 is a Slowness-Frequency-Coherence (SFC) plot obtained when processing acoustic data while a logging tool is moving.

FIG. 5 is an SFC plot obtained when processing acoustic data while the tool used to generate FIG. 3 is stationary.

FIG. 6 is a Slowness-Time-Coherence (STC) plot obtained when processing acoustic data while a logging tool is moving.

FIG. 7 is a STC plot obtained when processing acoustic data while the tool used to generate FIG. 4 is stationary

### DETAILED DESCRIPTION OF THE DRAWINGS

As noted the essence of the method of the invention involves, during operation to log a borehole or similar feature, periodically halting a logging tool supported on drillpipe; and making use in some way of the improved statistics and/or SNR that result from acquiring log data while the logging tool is stationary.

In the case of a nuclear logging tool this results in sections of log, acquired (in accordance with the method of the invention) while the tool is stationary, that exhibit superior statistical characteristics to the log data acquired while the tool is moving.

The log data acquired during the periods of no movement of the logging tool result from the fact that during such a time the detector of the tool detects more counts than would otherwise be the case when the tool is moving. As explained above this is what gives rise to improved statistics in the log data.

Also as mentioned above a section of a nuclear log exhibiting superior statistics may be used in various ways to improve confidence in a log section exhibiting poorer statistics.

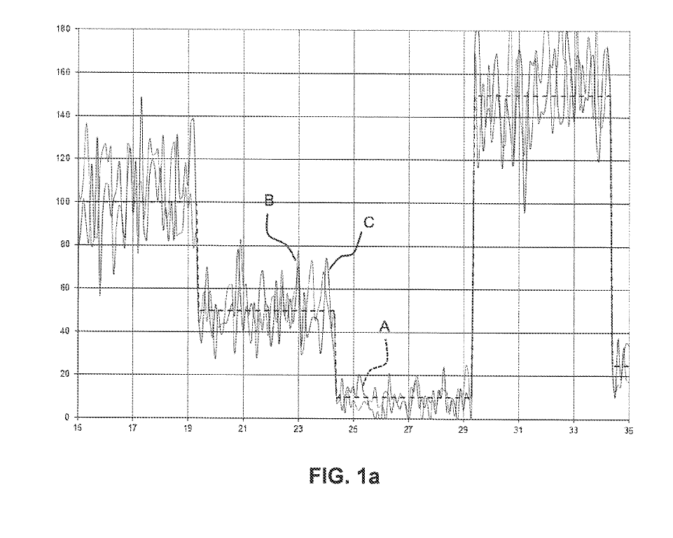

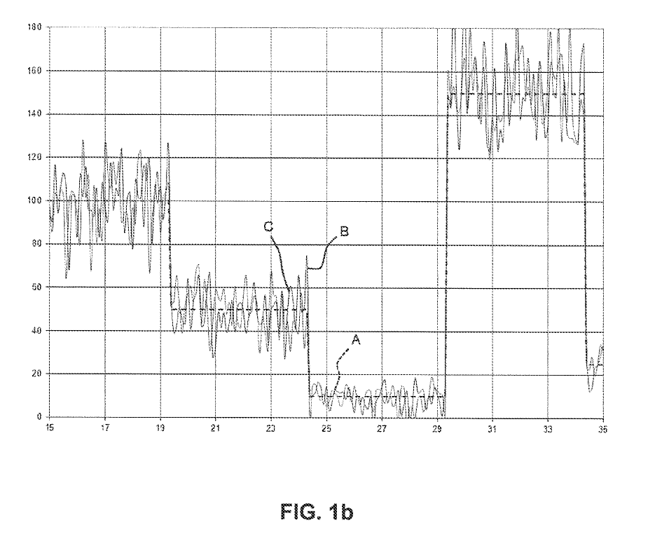

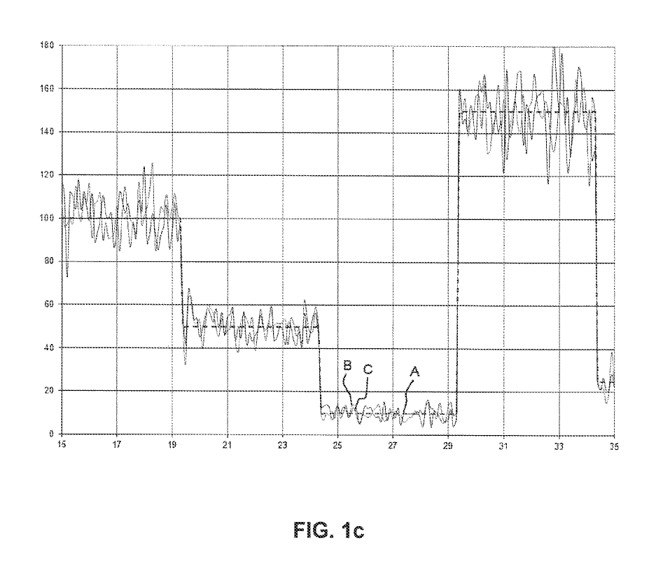

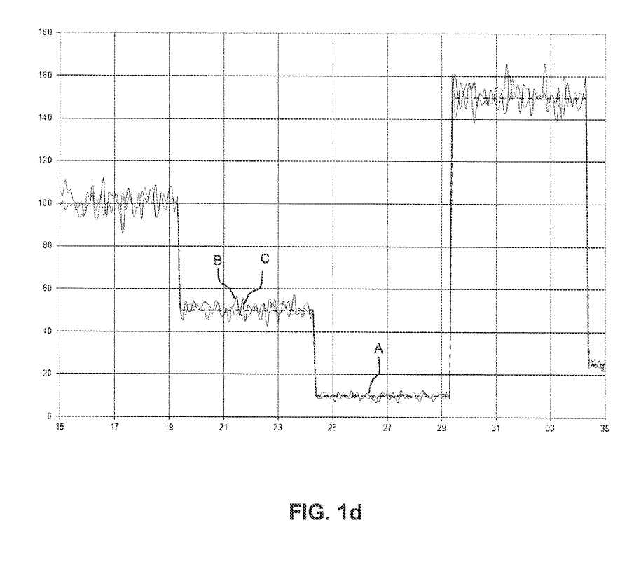

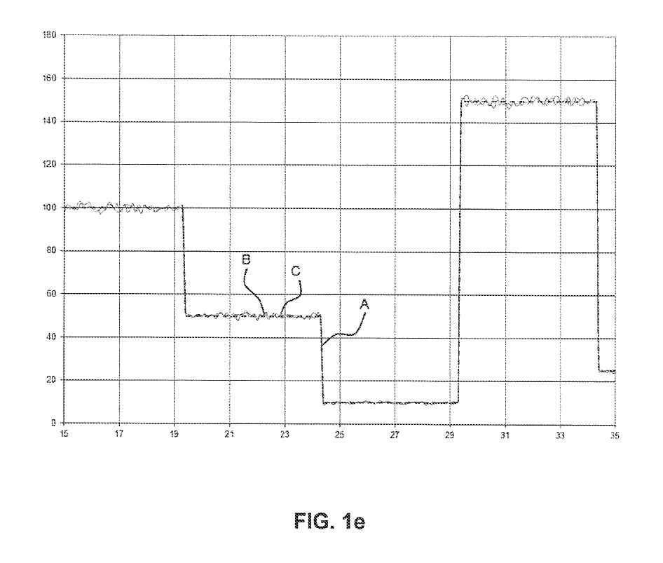

FIGS. 1a-1b illustrate the principle by which the method of the invention may be of use in the case of nuclear logs.

FIG. 1a shows by way of a dotted line A the true activity levels of a series of geological features referred to as “beds” (as will be familiar to the person of skill in the art) of varying levels of radioactivity. Solid log plot lines C and D show the simulated repeatability of logged activity values. As is apparent the logged values as a result of the above-described statistical effects do not reflect the true activity levels with any appreciable degree of accuracy.

FIGS. 1b to 1e show logging of the same beds at progressively slower logging speeds. It is clear from FIGS. 1b to 1e that the logged values B and C more and more closely reflect the true activity levels as the logging speed reduces. Furthermore the repeatability improves as the logging speed decreases, i.e. the differences between the two simulated passes and the true readings reduce. This demonstrates that a method, according to the invention, in which the logging speed temporarily is zero, will provide nuclear log data that highly closely tracks the true radioactivity of a formation (or the true amounts of energy returning to a logging tool that transmits radiation into the formation rather than relying on the natural activity levels of rock as in FIG. 1). The realisation that data acquired under such circumstances is valuable is an important aspect of the invention.

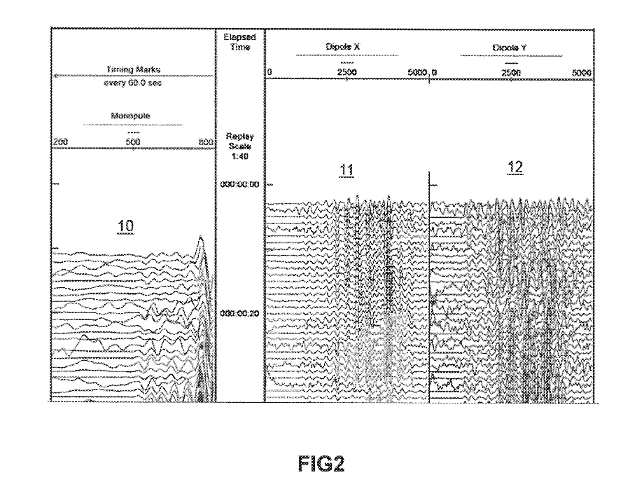

Comparable improvements may be brought about through use of an acoustic logging tool. As is described below such improvements may be shown graphically. FIGS. 2 to 7 therefore refer to the use of an acoustic logging tool in accordance with the method of the invention.

Noise contributions to acoustic waveforms associated with downhole acoustic tools derive from two sources: electronic and, as mentioned above, a tool induced vibration/shock component (so-called road noise). The latter source always dominates under normal logging situations so that electronic noise may normally be neglected.

Road noise originates from the sonde, or more usually the sonde ancillaries scraping along the inner surface of the borehole. This leads to a combination of shock and vibration, generating acoustic waves at the formation interface that are transmitted through the borehole as well as along the tool body. The noise spectrum of road noise is characteristically dominated by low frequencies in the audio range i.e. 500 Hz-5 KHz. For many older generation acoustic tools operating with transmitter centre frequencies above 10 Khz this is less of an issue, as relatively straightforward frequency filtering can be used to remove the noise component. The latest generations of dipole and quadrupole acoustic tools however are designed to operate precisely within this same frequency band. Well-designed tools and associated ancillaries such as centralisers, bumpers etc., when fitted appropriately, can mediate the problem to an acceptably low level for the majority of logging conditions. However in highly deviated and horizontal wells, the additional tool weight acting on the borehole, and coupled with supplementary standoffs, can lead to significant additional noise generation. In many cases the noise levels can equal or exceed the expected formation signal, making the processing requirements particularly challenging.

FIG. 2 shows a so-called “wiggle trace”, the nature and purpose of which are familiar to the person of skill in the art, indicating the effects of road noise in an acoustic log.

In FIG. 2 track 10 represents the output of a monopole acoustic source (with which the person of skill in the art also will be familiar) and tracks 11 and 12 respectively the orthogonal X and Y receiver outputs, plotted against time in microseconds (i.e. 200-1200 μsec and 0-5000 μsec. Thus the monopole transmitter of the logging tool transmits acoustic energy omni-directionally according to a pulse schedule determined by the (acoustic transmitter) energy source and its associated driver software.

As is clearly apparent the road noise has the effect of rendering ambiguous the onset of detected energy in the receivers. In particular the road noise makes it all but impossible to discern where relative to the X and Y receivers the received acoustic energy is detectable.

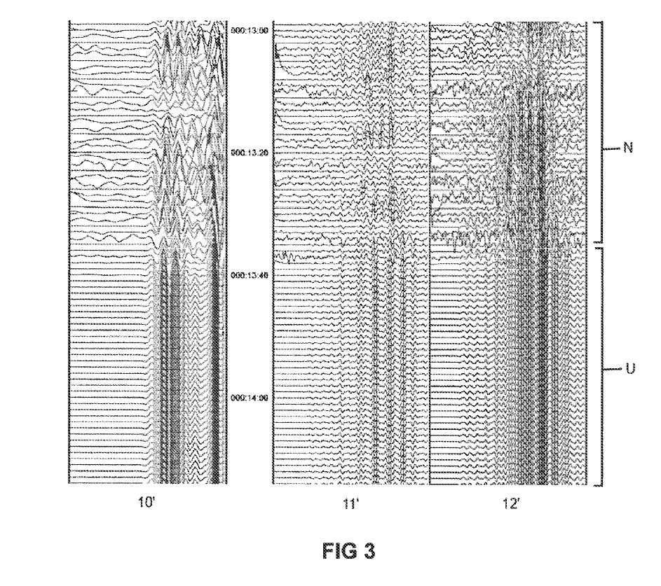

This may be contrasted with FIG. 3, in which after a certain period of logging (i.e. about 35 seconds in the example illustrated) the logging tool is halted in accordance with the method of the invention.

The result is a very stark transition from a road noise-affected section of each log represented by the section N to unaffected sections U in which only the acoustic energy generated by the monopole or dipole sources is detected.

These stationary sections U of channel measurement data normally discarded can as a result be post-processed to provide high signal-noise measurements on a selection of input sources.

Depending on the drilling rig size and capabilities, sections of drill pipe are removed in multiples of one, two or three sections at a time. For obvious time efficiency and hence economic reasons, three sections are generally preferred. However for the purpose of achieving more frequent stationary intervals with the significantly improved signal to noise benefit described herein, single sections of drill pipe could be selected.

A logging tool is typically made up of an array of receivers spread along and around its elongate body. These receivers record the waves propagated from the energy source that have passed through the formation surrounding the borehole. The incorporation of such an array is designed to provide redundancy via a processing gain, giving an improvement in the overall processing signal to noise compared to a sparse array.

The person of skill in the art would be aware that the wavefronts arriving at the receivers of the logging tool could be, among others, incident, reflected or refracted compressional, guided, shear and/or surface waves.

All of the waves propagate symmetrically up and down the borehole, and hence these different wavefronts are detected by the receivers at different times. The difference in arrival times divided by the distance between receivers yields the slowness for each type of wave.

Slowness can be estimated by using a signal processing technique that looks for similarity, also known as semblance or coherence, in waveforms across the array of receivers of the logging tool. The technique starts with an assumed arrival time and slowness for each wave type, then searches the set of waveforms for the time and slowness that maximise coherence.

An STC log displays readings of waveform coherence with respect to slowness and time, computed as a function of coherent energy to total energy. In other words this is a measure of the similarity between two or more functions; used with seismic waveforms to distinguish seismic events and to implement automatic picking schemes.

SFC in contrast calculates a unique slowness for each frequency component within the waveforms. Because of the reduced available energy in each frequency increment, the plot is more susceptible to noise.

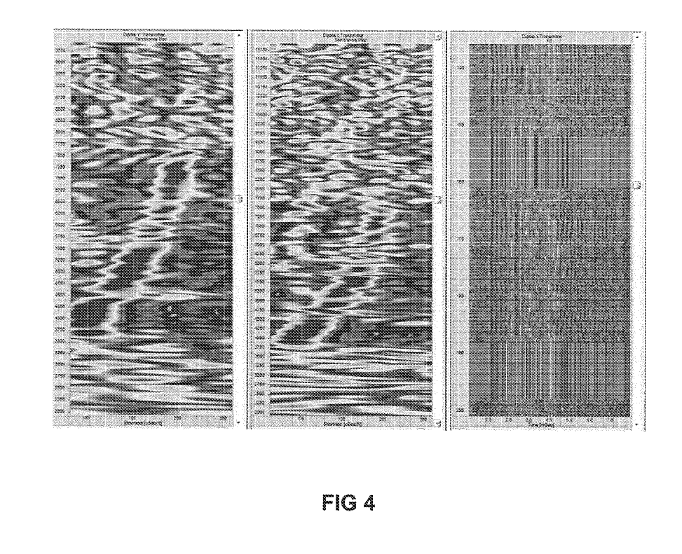

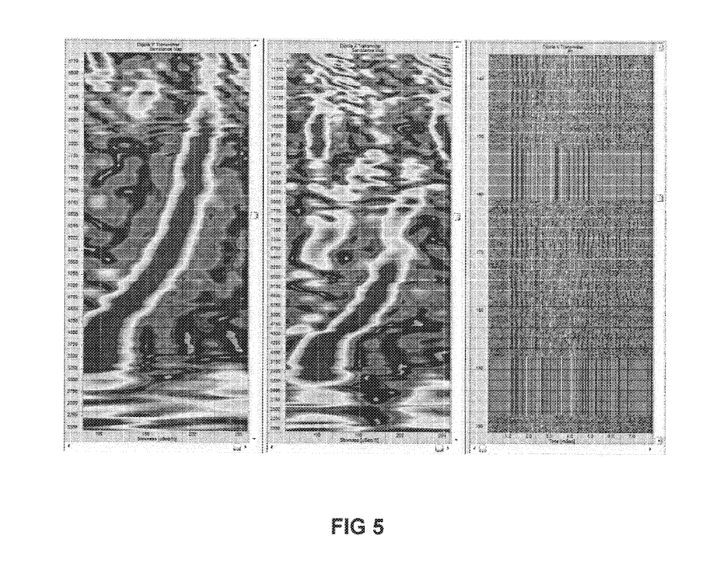

Comparing FIGS. 4 and 5, it can be appreciated that the SFC log obtained when the tool is stationary is clearer than the log plotted when the tool is moving.

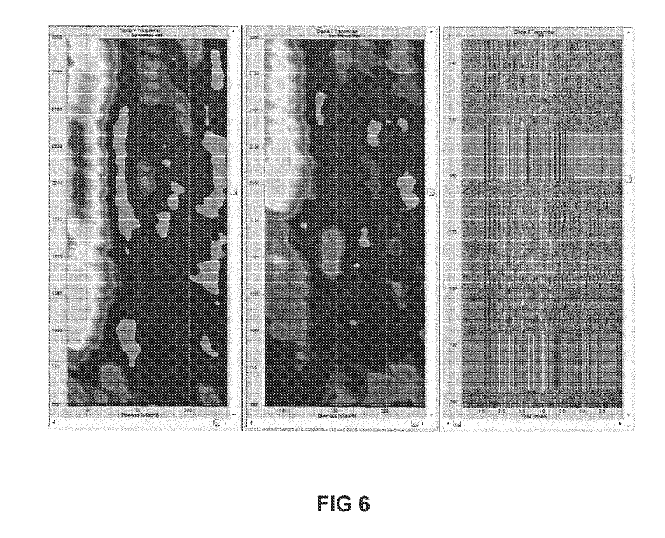

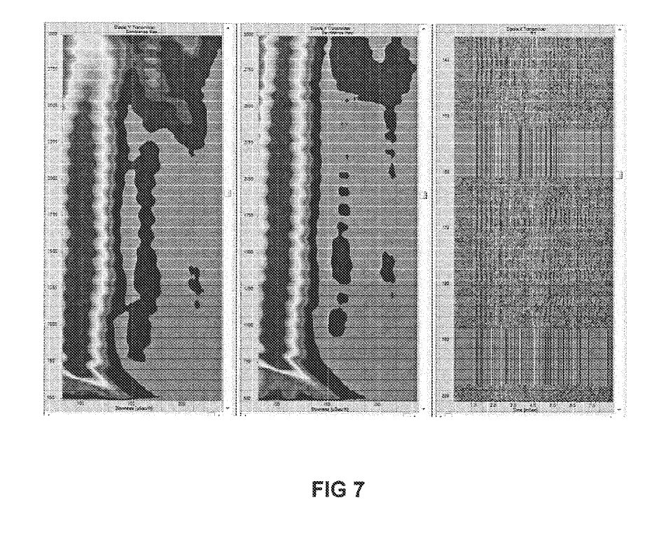

Similarly, comparing FIGS. 6 and 7, the STC log obtained when the tool is stationary (and hence not subjected to noise) is clearer than the STC log obtained when the tool is moving.

In FIGS. 4 and 5 the following key applies:
y-axis=frequency in Hz
x-axis=x-axis=slowness in μs/ft. used to extract the dispersion characteristics of the formation.

In FIGS. 6 and 7 the following key applies:
y-axis=time in microseconds,
x-axis=slowness in μs/ft. used to extract the slowness In the stationary waveform examples of FIGS. 4 to 7 no stacking was made, as the electronic noise levels are too small to benefit the processing

A short description of these processing techniques now follows:

Slowness-Time-Coherence (STC)
Receiver waveform array data are processed in the time domain. A fixed time window of length chosen by the operator is moved across the near receiver waveform with a cross-correlation-like statistic—normally semblance—applied across the remaining waveforms with increasing time move-outs. The method allows multiple modes within a received waveform to be identified by peaks in the semblance statistic vs. time across the waveform. In fast rock formations compressional, refracted shear and Stoneley energy can be recognised. The method provides a degree of noise immunity due to the receiver redundancy, but at the expense of vertical resolution.

Slowness-Frequency-Coherence (SFC)
Acoustic energy originating from dipole sources propagates within the borehole predominantly in the form of guided modes. Such modes are dispersive (v=v(freq)) in nature. For example the low frequency energy within a flexural guided mode travels at the shear velocity of the formation of interest. It is important therefore that appropriate filtering of the waveform data is undertaken or else a bias can result. The shape of the dispersion curve is of further interest as it is a function of the radial properties of the formation amongst other things. A number of methods are available to extract the dispersion properties of the acoustic waveforms, such as that by NolteNolte, D., Rao, R., and Huang, X. 1997. Dispersion Analysis of Split Flexural Waves. Borehole Acoustics and Logging Consortium, MIT. Other methods are also known

Whilst some SFC methods are inherently more robust than others, all processing approaches used are particularly prone to road noise contamination due to the reduced spectral amplitude components within each frequency band examined. For example the plots can become discontinuous, broken up and dominated by road noise components typically passing the receiver array in the form of low frequency Stoneley energy within the borehole or vibrational components from the tool itself.

Furthermore such road noise energy can pass the receiver array in either direction leading to possible inverted slowness-frequency plots.

A stationary acoustic tool used in accordance with the method of the invention is no longer subject to such road noise contamination, and the noise source is now only electronic in origin. Overall signal to noise levels are now subject to transmitter output, and any electronic noise levels associated with the front end components. Typical signal to noise levels may now easily exceed 50:1, depending on borehole geometry and formations. Further minor stacking of stationary waveforms can potentially lead to negligible noise concerns, although this is unlikely to be required.

Processing methods well known to the industry are typically used to extract slowness in μsec/ft (reciprocal velocity) and dispersion information from arrays of waveform data.

It is apparent from FIGS. 4 to 7 that significant improvements in SNR in acoustic logs arises from use of the method of the invention, regardless of whether STC or SFC processing methods are used.

Similar improvements may through use of the method of the invention be brought about in the other log types mentioned herein.

The listing or discussion of an apparently prior-published document in this specification should not necessarily be taken as an acknowledgement that the document is part of the state of the art or is common general knowledge.

Preferences and options for a given aspect, feature or parameter of the invention should, unless the context indicates otherwise, be regarded as having been disclosed in combination with any and all preferences and options for all other aspects, features and parameters of the invention.

1. A method of improving geological log data comprising the steps of:
(i) moving a logging tool conveyed using plural lengths of drillpipe secured seriatim together in a string in a borehole in a formation while operating the logging tool to obtain log data of a first category;
(ii) periodically halting the logging tool supported by the drillpipe;
(iii) while the logging tool is halted, obtaining log data of at least a second category; and
(iv) processing or storing the log data of the second category.

2. A method according to claim 1 wherein processing or storing the data of the second category includes using the log data of the second category to improve the quality of the data of the first category.

3. A method according to claim 1 wherein processing or storing the data of the second category includes combining the data of the first and second categories.

4. A method according to claim 1 wherein processing or storing the data of the second category includes comparing the data of the first and second categories with one another.

5. A method according to claim 1 when repeated multiple times.

6. A method according to claim 1 including the step of removing one or more stands of drillpipe at a time from the string while the logging tool is halted.

7. A method according to claim 1 wherein the logging tool is or includes a nuclear logging tool sonde.

8. A method according to claim 1 wherein the logging tool is or includes a nuclear logging tool sonde and wherein the nuclear logging tool sonde is or includes a sonde selected from the list comprising a natural Gamma sonde, a spectral Gamma sonde and an induced Gamma spectroscopy sonde.

9. A method according to claim 1 wherein the logging tool is or includes a nuclear logging tool sonde and wherein the log data of the first category are log data acquired while the nuclear logging tool sonde is moving in the borehole and the log data of the second category are log data acquired while the nuclear logging tool sonde is stationary in the borehole, the log data of the second category exhibiting lower fractional standard deviation values than the log data of the first category.

10. A method according to claim 1 wherein the logging tool sonde is or includes an acoustic logging tool sonde.

11. A method according to claim 1 wherein the logging tool sonde is or includes an acoustic logging tool sonde and wherein the the log data of the first category are log data acquired while the acoustic logging tool sonde is moving in the borehole and the log data of the second category are log data acquired while the acoustic logging tool sonde is stationary in the borehole, the log data of the second category exhibiting less noise than the log data of the first category.

12. A method according to claim 1 wherein the logging tool sonde is or includes an acoustic logging tool sonde and wherein the log data of the first and second categories are subject to processing according to one or more methods selected from the group comprising slowness-time-coherence (STC) processing and slowness-frequency-coherence (SFC) processing.

13. A method according to claim 1 wherein the logging tool is or includes a nuclear magnetic resonance logging (NMR) sonde.

14. A method according to claim 1 wherein the logging tool is or includes a nuclear magnetic resonance logging (NMR) sonde and wherein the data of the first category are or include data indicative of one or more transverse relaxation times (T₂ spectra) and/or data indicative of one or more longitudinal relaxation times (T₁ spectra).

15. A method according to claim 1 wherein the logging tool is or includes a nuclear magnetic resonance logging (NMR) sonde; wherein the data of the first category are or include data indicative of one or more transverse relaxation times (T₂ spectra) and/or data indicative of one or more longitudinal relaxation times (T₁ spectra); and wherein when the data of the first category are or include data indicative of one or more transverse relaxation times (T₂ spectra) the data of the second category are or include data indicative of one or more longitudinal relaxation times (T₁ spectra), and vice versa.

16. A method according to claim 1 wherein the logging tool is or includes a nuclear magnetic resonance logging (NMR) sonde; wherein the data of the first category are or include data indicative of one or more transverse relaxation times (T₂ spectra) and/or data indicative of one or more longitudinal relaxation times (T₁ spectra); wherein when the data of the first category are or include data indicative of one or more transverse relaxation times (T₂ spectra) the data of the second category are or include data indicative of one or more longitudinal relaxation times (T₁ spectra), and vice versa; wherein the data of the second category are or include data indicative of one or more longitudinal relaxation times (T₁ spectra), and wherein the method includes repeatedly sampling data in the second category while the logging tool is halted.

17. A method according to claim 1 wherein the logging tool is or includes a nuclear magnetic resonance logging (NMR) sonde; wherein the data of the first category are or include data indicative of one or more transverse relaxation times (T₂ spectra) and/or data indicative of one or more longitudinal relaxation times (T₁ spectra); wherein when the data of the first category are or include data indicative of one or more transverse relaxation times (T₂ spectra) the data of the second category are or include data indicative of one or more longitudinal relaxation times (T₁ spectra), and vice versa; and including repeatedly sampling data in the second category while the logging tool is halted and varying a value of inter-echo pulse spacing during such sampling whereby to produce data of the second category that are indicative of a diffusion spectrum.

18. A method according to claim 1 wherein the logging tool is or includes a nuclear magnetic resonance logging (NMR) sonde; wherein the data of the first category are or include data indicative of one or more transverse relaxation times (T₂ spectra) and/or data indicative of one or more longitudinal relaxation times (T₁ spectra); wherein when the data of the first category are or include data indicative of one or more transverse relaxation times (T₂ spectra) the data of the second category are or include data indicative of one or more longitudinal relaxation times (T₁ spectra), and vice versa; and including repeatedly sampling data in the second category while the logging tool is halted and varying a value of frequency of NMR pulse sequence during such sampling whereby to produce data of the second category that are indicative of characteristics of different regions of the formation.

19. A method according to claim 1 further including creating a guide log of density of log data against log depth whereby to assist in the identification of log data respectively of the first category and the second category.

20. A method according to claim 1 further including creating a guide log of density of log data against log depth whereby to assist in the identification of log data respectively of the first category and the second category; and including the step of superimposing the guide log onto the log data of the first and second categories.

21. A method according to claim 1 further including creating a guide log of density of log data against log depth whereby to assist in the identification of log data respectively of the first category and the second category; and including the step of adding one or more measures of error confidence to the guide log.
